(19) United States
(12) Patent Application Publication
(10) Pub. No.: US 2014/0032654 A1
(43) Pub. Date: Jan. 30, 2014

(54) INFORMATION SERVICE PLATFORM PROVIDING DYNAMIC DISTRIBUTION OPERATORS

(71) Applicant: Tso-Sung HUNG, Zhubei City (TW)

(72) Inventor: Tso-Sung HUNG, Zhubei City (TW)

(21) Appl. No.: 14/021,571

(22) Filed: Sep. 9, 2013

Related U.S. Application Data
(63) Continuation-in-part of application No. 12/729,092, filed on Mar. 22, 2010.

(51) Int. Cl. H04L 29/08

(52) U.S. Cl. CPC H04L 67/10
USPC 709/203

(57) ABSTRACT

An information service platform providing dynamic distribution operators is to connect to a plurality of clients and connect the clients with a plurality of application service units. The information service platform includes a connection port distribution unit, a plurality of operator units and the application service units. The connection port distribution unit provides connection ports corresponding to the clients to connect the operator units with the clients. The operator units provide an automatic question and answer function, and transfer the clients to connection-intended application service units after finishing question and answer with the clients. Through the connection port distribution unit and operator units, the problem of network congestion caused by multiple users connecting to one server can be resolved.

This application is a continuation-in-part, and claims priority, of from U.S. patent application Ser. No. 12/729,092 filed on Mar. 22, 2010, entitled “INFORMATION SERVICE PLATFORM EQUIPPED WITH DYNAMIC DISTRIBUTION OPERATORS”, the entire contents of which are hereby incorporated by reference.

### FIELD OF THE INVENTION

The present invention relates to an information service platform and particularly to an information service platform that provides dynamic distribution function.

### BACKGROUND OF THE INVENTION

At the information explosion age now, users usually download data or search information through network. The conventional data download service such as File Transfer Protocol (FTP in short hereinafter) provides a connection platform to connect users with a server. The users can connect and communicate with the server through FTP to access files or data.

Each server has an Internet Protocol (IP in short hereinafter). When the users want to connect to different servers, they have to do it manually. Changing the IP to connect to different servers is inconvenient. Moreover, FTP is synchronous transmission. In the event that too many users try to connect to the server at the same time, line congestion could easily happen and result in connection interruption. Although many systems have provided continuous transmission service to execute line reconnection and file transmission according to the interrupted condition, line reconnection not only is time-consuming, network congestion of the server also easily occurs when many people execute line connection at the same time. Moreover, FTP, aside from file transmission, also cannot provide other functions such as weather inquiry, traffic instant information, disaster information and the like. While users can get the instant information by searching on the Internet, the information is scattered widely to result in search not easy, and network congestion is prone to take place at the peak hours.

### SUMMARY OF THE INVENTION

The primary object of the present invention is to solve the problem of communication congestion that easily occurs when a great number of people try to connect to a single server at the same time.

Another object of the invention is to resolve the problem of changing the IP manually to connect to different servers.

Yet another object of the invention is to solve the problem of connection interruption caused by line congestion because of network transmission protocol.

To achieve the foregoing objects, the present invention proposes an information service platform providing dynamic distribution operators to connect to a plurality of clients. The information service platform includes a plurality of application service units and a dynamic routing system connected to the clients. The application service units provide different information service functions. The dynamic routing system includes an asynchronous processing unit, a connection port distribution unit connected to the asynchronous processing unit, a plurality of operator units connected to the connection port distribution unit, and a dynamic distribution unit connected to the operator units. The clients are connected to the connection port distribution unit through the asynchronous processing unit. The asynchronous processing unit processes connection signals of the clients asynchronously. The connection port distribution unit provides connection ports corresponding to the clients to connect the operator units with the clients. The operator units provide an automatic question and answer function, and transfer the clients to the connection-intended application service units after having finished the question and answer process with the clients. The dynamic distribution unit dynamically distributes the clients that have been processed by the operator units to the selected application service units.

By means of the technique set forth above, the invention can process the signals asynchronously through the asynchronous processing unit to avoid connection interruption between the clients and application service units due to line congestion. Moreover, through the connection port distribution unit and operator units, the clients are transferred to connect to the connection-intended application service units, hence the problem of server network congestion caused by a great number of clients trying to connect to a single server at the same time can be averted. In addition, through the dynamic distribution function provided by the dynamic distribution unit, congestion caused by a great number of the clients trying to make inquiry, access, upload and download to the same application service unit at the same time also can be avoided. The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a configuration block diagram of an embodiment of the invention.

FIG. 2 is a block diagram of an embodiment of the dynamic routing system of the invention.

FIG. 3 is a process flowchart of an embodiment of the invention.

FIG. 4A is a schematic view of an embodiment of linking to the connection ports according to the invention.

FIG. 4B is a schematic view of another embodiment of linking to the connection ports according to the invention.

### DETAILED DESCRIPTION OF THE PREFERRED EMBODIMENTS

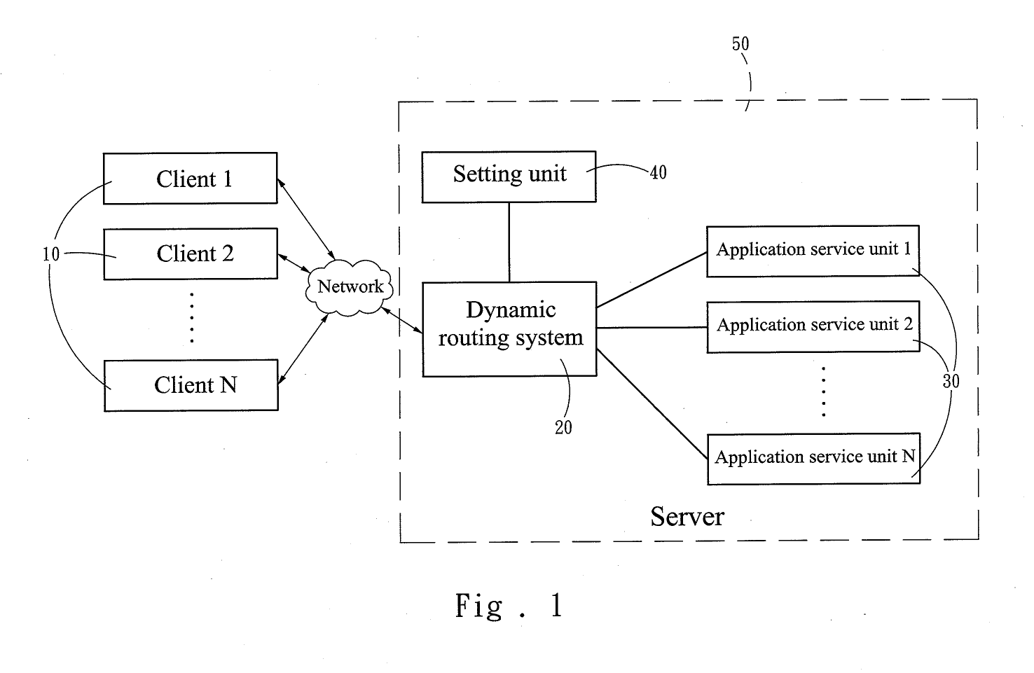

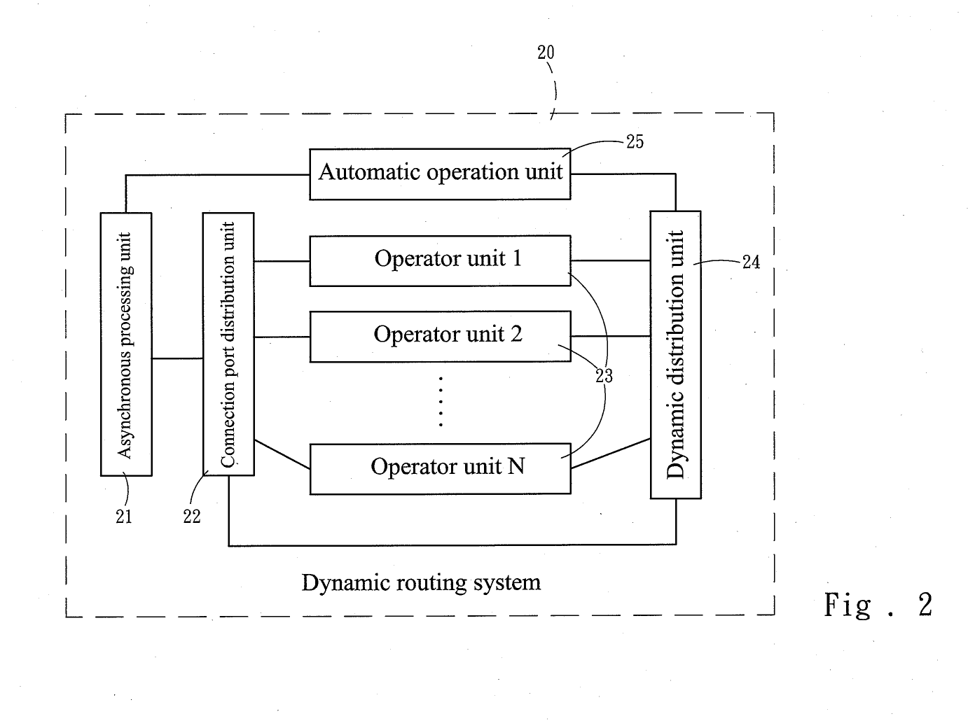

Please refer to FIGS. 1 and 2, the present invention aims to propose an information service platform that provides dynamic distribution operators. It is located in a server 50 to allow a plurality of clients 10 to connect to the server 50 through a single IP of network. The information service platform comprises a plurality of application service units 30 and a dynamic routing system 20 connected to the clients 10. The application service units 30 can provide different information services, such as data download and upload, weather inquiry, traffic congestion route inquiry, earthquake information inquiry and statics, stock price inquiry and the like.

The dynamic routing system 20 includes an asynchronous processing unit 21, a connection port distribution unit 22 connected to the asynchronous processing unit 21, a plurality of operator units 23 connected to the connection port distribution unit 22 and a dynamic distribution unit 24 connected to the operator units 23.

The clients 10 are connected to the connection port distribution unit 22 through the asynchronous processing unit 21. The connection between the clients 10 and dynamic routing system 20 can be wired network, wireless network, telephones, cordless telephones, GPRS (General Packet Radio Service) or satellites. In addition, the operator units 23 also provide a function of confirming whether the clients 10 conform to connection regulation. The connection regulation can be communication protocol, control protocol, information protocol and command format, and acceptable version of the clients 10. If the clients 10 do not conform to the regulation, line connection is cut off. Furthermore, in the event that the clients 10 are granted with priority in connection, they are processed according to their priorities. The asynchronous processing unit 21 processes connection signals of the clients 10 asynchronously, thus can avoid connection interruption caused by line congestion between the clients 10 and application service units 30.

The connection port distribution unit 22 provides connection ports corresponding to the clients 10 to connect the operator units 23 with the clients 10. The operator units 23 transfer the clients 10 to the connection-intended application service units 30. It is to be noted that the operator units 23 have a question and answer function and can automatically inquire requests from the clients 10 and can make more inquiry for details or execute distribution of services after receiving the answers of the clients 10. In addition, the operator units 23 also can confirm whether the answered contents complying with the regulations of the application service units 30, and verify whether the application service units 30 chosen by the clients 10 exist; if the outcome is negative, the requested service is denied.

For instance, the clients 10 are connected to a single server 50 via an IP or domain. The server 50 provides a plurality of connection ports via the connection port distribution unit 22 to connect to the clients 10, and the operator units 23 are connected with the clients 10 through the connection ports as well. After the question and answer process is finished, the operator units 23 connect the clients 10 to the requested application service units 30 via the dynamic distribution unit 24. Therefore, the problem that one server 50 can only process multiple clients 10 in sequence can be overcome to alleviate congestion of the server 50.

The dynamic distribution unit 24 dynamically distributes the clients 10 that have been processed by the operator units 23 to the selected application service units 30. Moreover, the dynamic routing system 20 further includes an automatic operation unit 25 which provides automatic connection between the clients 10 and the set application service units 30 and transmits information thereof. For instance, the clients 10 can preset or instantly download earthquake statistic data, stock price information and weather forecast information. Once the clients are connected to the information service platform of the invention, the statistic data and information preset previously can be automatically downloaded to provide the users a simpler and faster use environment.

The dynamic routing system 20 further is connected to a setting unit 40 to set parameters in the dynamic routing system 20. The parameter setting content can include network connection setting (such as IP, Domain name), setting of connection ports of the operator units 23, setting of quantity of the operator units 23, setting of connection ports of the application service units 30, setting of quantity of the application service units 30, regulations to be complied by the clients 10 to access the application service units 30, such as version number, account number, password, editing of question and answer process and answering speed and the like.

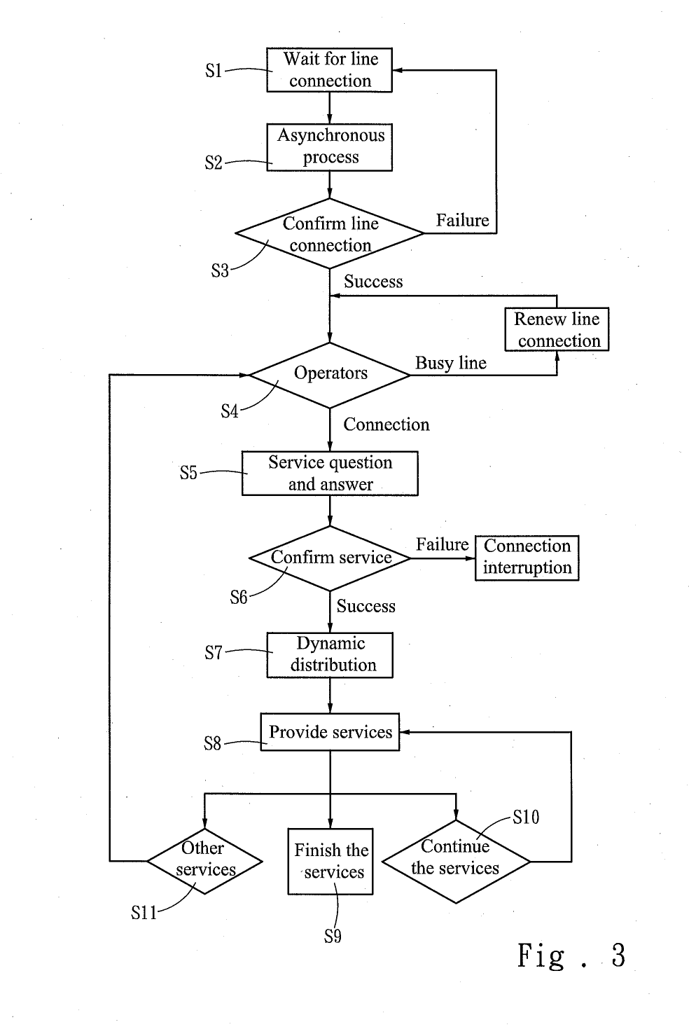

Please refer to FIG. 3 for an embodiment of process flow of the invention, also referring to FIGS. 1, 2, 4A and 4B. It is to be noted that the invention is adopted in an environment in which a single server provides services to multiple clients 10, such as allowing a plurality of clients 10 to simultaneously book transportation tickets, make inquiry or cancel tickets or the like. The process includes steps S1-S11 as follows:

S1: Wait for line connection: The setting unit 40 sets parameters of the dynamic routing system 20, and confirms unobstructed connection and wait for connection of the clients 10.

S2: Asynchronous process: The asynchronous processing unit 21 processes signals of the clients 10 asynchronously so that two-way communication is established between the clients 10 and dynamic routing system 20 to maintain connection without interruption due to line congestion.

S3: Confirm line connection: After the clients 10 have connected with the connection port distribution unit 22 through the asynchronous processing unit 21, in the event that connection fails or abnormal connection happens, the line connection is cut off and step S1 renews to wait for line connection; if the connection is normal, proceed the next step.

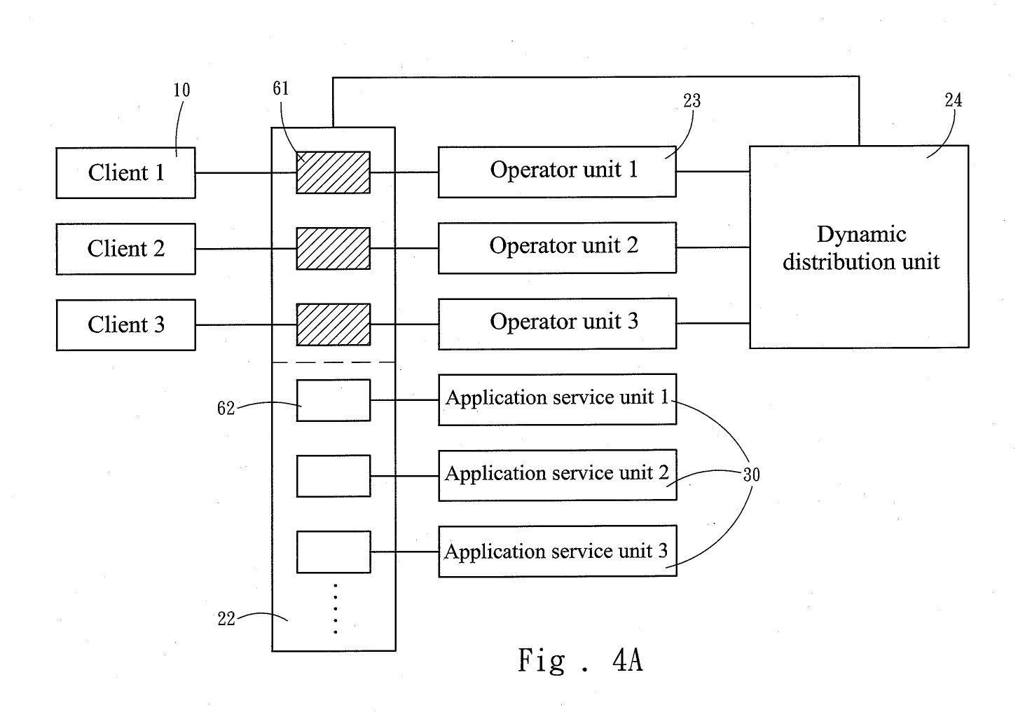

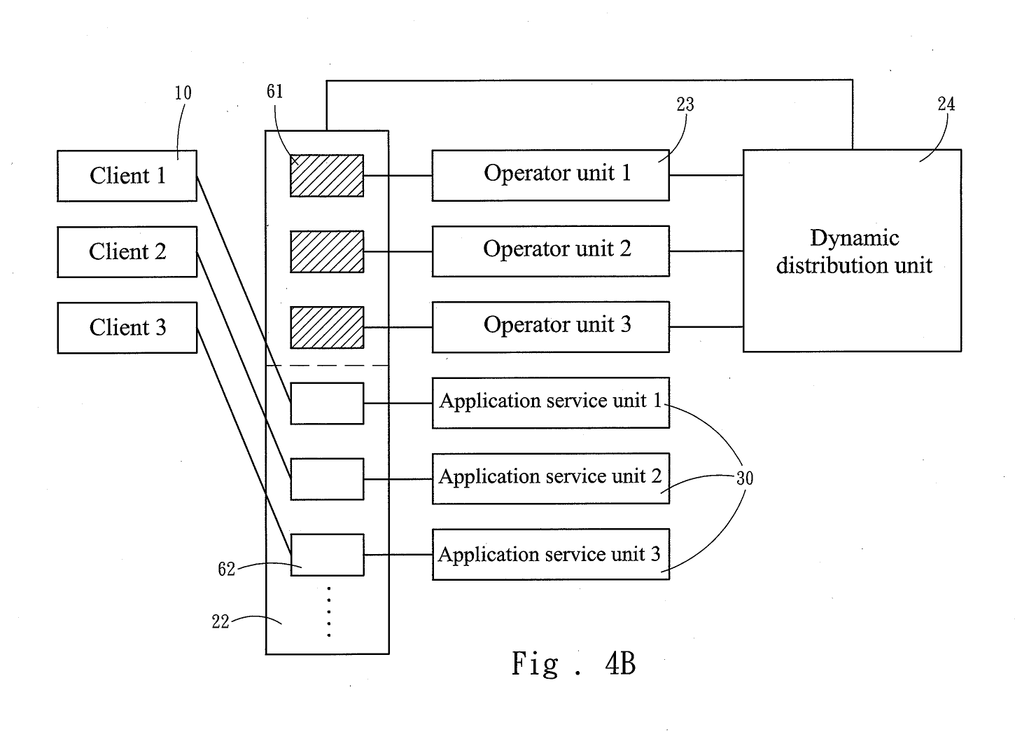

S4: Operators: The connection port distribution unit 22 provides connection ports for the clients 10 to establish connection. In this embodiment, as shown in FIGS. 4A and 4B, where the asynchronous processing unit 21 is omitted to facilitate discussion, the clients 10 are directly connected to the connection port distribution unit 22. The connection ports can be divided into multiple operator connection ports 61 and multiple service connection ports 62. After the clients 10 have been processed asynchronously, they are connected to the operator units 23 via the operator connection ports 61. In the event that busy line happens to the operator units 23, line connection renews until connecting to the operator units 23.

S5: Service question and answer: The operator units 23 ask questions and the clients 10 answer to confirm services requested. It is to be noted that the operator units 23 have a priority mechanism to provide the clients 10 having priority to access at a higher priority.

S6: Confirm services: If the operator units 23 have confirmed that services conform to the regulations, they transfer the connection signals of the clients 10 to the dynamic distribution unit 24; however, if the services do not conform to the regulations, line connection is disconnected.

S7: Dynamic distribution: Referring to FIG. 4B, the operator units 23 get the information of the service connection ports 62 of the dynamic distribution unit 24 according to the service question and answer from the clients 10, send the information of the corresponding service connection ports 62 to the clients 10 and connection signals of the clients 10 to the dynamic distribution unit 24. The dynamic distribution unit 24 distributes the information of the clients 10 to the application service units 30 and also confirms the connection-intended application service units 30, and then activates the application service units 30 to establish connection between the service connection ports 62 and clients 10. After the clients 10 have received the aforesaid information, they are connected to the requested application service units 30 via the service connection ports 62. In the event that the services do not conform to the regulations, line connection is cut off. After the aforesaid question and answer process and confirmation have been finished, the operator units 23 continue and wait for new clients 10 to establish connection through the operator connection ports 61, and the dynamic distribution unit 24 distributes and monitors the service connection ports 62 to provide the number of idle service connection ports 62 to the operator units 23.

S8: Provide services: The application service units 30 provide services of server programs for the service connection ports 62. The application service units 30 provide services for the connected clients 10, such as confirm, inquire or cancel the booked ticket or the like.

S9: Finish the services: Finish the services requested by the clients 10, and finish connection.

S10: Continue the services of the application service units 30. Aside from directly finishing the line connection, another option of maintaining the line connection and continuing providing services for the same application service unit 30 also can be chosen.

S11: Other services: In addition to the options at steps S8 and S9, return to step S4 also can be chosen to renew connection with the operator units 23, then through the question and answer process of the operator units 23 to understand the requested service contents.

It is to be noted that the connection ports previously discussed in the invention are port number of Transmission Control Protocol (TCP), and the officially acknowledged connection port number is 65,535. Hence there are sufficient in practical use. Moreover, the connection ports also can be virtual IP which can be similarly distributed and used for the application service units 30.

As a conclusion, the invention uses the asynchronous processing unit to process signals asynchronously to avoid connection interruption caused by line congestion between the clients and application service units. Moreover, through the connection port distribution unit and operator units, the clients can be transferred to the requested application service units, the problem of server network congestion when a great number of clients is connected to a single server at the same time can be prevented. In addition, through the dynamic distribution function provided by the dynamic distribution unit, congestion caused by a great number of clients to do inquiry or access of one application service unit at the same time also can be alleviated. Furthermore, through the automatic operation unit to make data inquiry, download or upload automatically for preset or instant requests, a simpler and easier operation environment can be provided to the clients.

What is claimed is:

1. An information service platform providing dynamic distribution operators being located in a server to allow a plurality of clients to connect to the server through a single Internet Protocol of network, comprising:
a plurality of application service units to provide different information service functions; and
a dynamic routing system which is connected to the clients and includes an asynchronous processing unit, a connection port distribution unit connected to the asynchronous processing unit, a plurality of operator units connected to the connection port distribution unit and a dynamic distribution unit connected to the operator units; the clients being connected to the connection port distribution unit through the asynchronous processing unit which processes connection signals of the clients asynchronously, the connection port distribution unit providing connection ports corresponding to the connected clients to connect the operator units with the clients, the operator units including an automatic question and answer function and transferring the clients to the connection-intended application service units after finishing question and answer with the clients, the dynamic distribution unit dynamically distributing the clients processed by the operator units to the selected application service units.

2. The information service platform of claim 1, wherein the operator units further provide a function of confirming whether requests of the clients conform to regulated services.

3. The information service platform of claim 1, wherein the operator units further include a priority mechanism to provide the clients granted with priority to access at the priority.

4. The information service platform of claim 1, wherein the dynamic routing system further is connected to a setting unit to set parameters in the dynamic routing system.

5. The information service platform of claim 1, wherein the clients are connected to the connection port distribution unit through the asynchronous processing unit in wired network connection or wireless network connection.

6. The information service platform of claim 1, wherein the clients are connected to the connection port distribution unit through the asynchronous processing unit via telephones, cordless telephones, GPRS (General Packet Radio Service) or satellite connection.

7. The information service platform of claim 1, wherein the connection port distribution unit is connected to an automatic operation unit which provides automatic connection between the clients and the set application service units and transmits information thereof.

8. The information service platform of claim 1, wherein the connection port distribution unit provides a plurality of operator connection ports and a plurality of service connection ports, the clients connecting to the operator units via the operator connection ports to process the automatic question and answer therewith, the operator units transferring the clients to the service connection ports after the question and answer is finished to connect to the requested application service units via the dynamic distribution unit, such that the clients are connected to the application service units through the service connection ports.
